(19) United States
(12) Patent Application Publication
(10) Pub. No.: US 2007/0137601 A1
(43) Pub. Date: Jun. 21, 2007

(54) Improved driveability and reduced emissions during engine start-up

(76) Inventor: Rudolf H. Stanglmaier, (US)

Correspondence Address: SHERIDAN ROSS PC, 1560 BROADWAY, SUITE 1200, DENVER, CO, 80202, US

(21) Appl. No.: 10/567,180

(22) PCT Filed: Jul. 15, 2004
(86) PCT No.: PCT/US04/22818

§ 371 Date: Aug. 10, 2006

Related U.S. Application Data
(60) Provisional application No. 60/493,038, filed on Aug. 5, 2003.

(51) Int. Cl. F02M 1/00; F02M 37/20

(52) U.S. Cl. 123/179.16; 123/516

(57) ABSTRACT

The present invention is related to improved derivability and reduced emissions during engine startup. In particular, fuel vapor is drawn from the fuel tank at or immediately prior to engine startup. The engine is then run using the fuel vapor, to at least partially warm the engine. Following the initial startup period, during which the engine becomes at least partially warm, liquid fuel is provided to the engine.

### CROSS-REFERENCED RELATED APPLICATIONS

This application claims the benefit of U.S. Provisional Application Ser. No. 60/493,038, filed Aug. 5, 2003, the entire disclosure of which is hereby incorporated herein by reference.

### FIELD OF THE INVENTION

The present invention is directed to providing improved drivability and reduced emissions in liquid-fuel spark-ignited engines. More particularly, the present invention extracts the most volatile fraction of the fuel from the fuel tank using a vacuum, on demand, in order to provide improved drivability and reduced emissions during engine startup.

### BACKGROUND OF THE INVENTION

A disproportionately high fraction of the emissions of unburned hydrocarbons from gasoline powered vehicles is emitted during the first minute or two following a cold start. This occurs because 1) the catalyst is cold and cannot oxidize the hydrocarbons emitted, and 2) because the engine must be substantially over-fueled in order to achieve stable combustion. This over-fueling is a direct result of the difficulties in fully vaporizing gasoline (and other multi-component liquid fuels) when the engine temperatures are low.

During start-up, more fuel than required for complete combustion must be introduced to the engine. Only the most volatile fraction of this fuel vaporizes and is combusted (as little as 10-15% in many cases), while the least volatile fraction of the fuel remains in the intake port or cylinder. Some of the excess low-volatility fuel is emitted as unburned hydrocarbons. As the engine warms up, this fuel vaporization improves and some of the low-volatility fuel in the intake is combusted, but it is difficult to account for fuel that was injected in previous cycles and the engine drivability (driver perception) can be poor.

### SUMMARY OF THE INVENTION

The present invention improves cold-start behavior of gasoline (and other liquid-fuel spark-ignited engines) by selectively using the most-volatile fraction of the fuel during initial start-up and the first few seconds following the start-up. The method of the invention involves selecting or extracting the most volatile fraction of the fuel by exposing the fuel tank to sub-atmospheric pressure (vacuum). The most volatile fraction of the fuel vaporizes under reduced ambient pressure (even at low temperature), and the vapor fraction of the fuel is extracted and provided or metered into the engine for start-up. Once the engine temperature begins to rise following start-up, conventional fueling with the liquid fuel fraction from the tank can be resumed. In accordance with embodiments of the present invention, conventional fueling with the liquid fuel fraction from the tank can resume once the engine's coolant temperature sensor reaches a predetermined or selected level. The switch to operation using the conventional fuel system can be performed gradually, by enabling the conventional port-fuel injectors at a reduced duty cycle while the start-up fuel is gradually phased out as the engine warms up. Alternatively, the switch to operation using the conventional fuel system can be performed abruptly.

### BRIEF DESCRIPTION OF THE DRAWINGS

FIG. 1 is a schematic illustration of an engine incorporating an assembly in accordance with embodiments of the present invention; and

FIG. 2 is a flowchart illustrating aspects of the operation of embodiments of the present invention.

### DETAILED DESCRIPTION

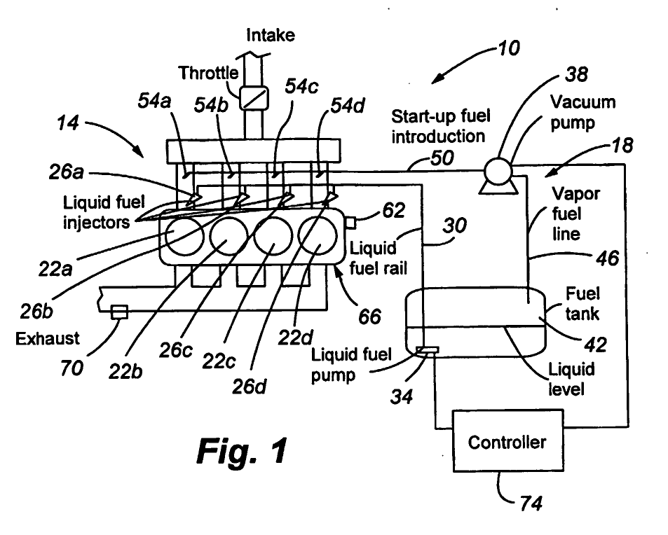

Referring to FIG. 1, an apparatus 10 of the present invention is schematically illustrated and includes an engine 14 and an assembly 18 that reduces the ambient pressure in the fuel tank 42 in connection with providing the high volatile fraction of the fuel to the engine 14. The engine 14 is a spark-ignited engine that includes a number of cylinders 22a, 22b, 22c, 22d that receive all, or substantially all, liquid fuel. The liquid fuel can be defined to include gasoline, alcohol, and/or gasoline-alcohol blends such as M85, E85 or any other multi-component liquid fuel for use in a spark-ignited engine. The liquid fuel can be input by liquid fuel injectors 26a, 26b, 26c, 26d. Each of the liquid fuel injectors 26a-26d communicates with one of the cylinders 22a-22d, respectively, in the context of supplying liquid fuel to that particular cylinder. In other embodiments, the number of fuel injectors is different from the number of engine cylinders 22a-22d, such as there being only one fuel injector for all cylinders.

The liquid fuel is supplied to the liquid fuel injectors 26a-26d using a liquid fuel rail 30 that is connected to the liquid fuel pump 34. The liquid fuel pump 34 may be operated or activated after engine start-up, which is typically after about the first 30-60 seconds from ignition or activation of the engine 14.

The assembly 18 that provides reduced ambient pressure fuel may include a pressure reducing device 38 for establishing or creating a negative pressure that is applied to the fuel in a fuel tank 42 and which is less than atmospheric or ambient pressure. Alternatively, engine vacuum alone may be used to create reduced pressure in the fuel tank 42, in which case the pressure reducing device 38 may comprise a vacuum accumulator and valve. The assembly 18 also includes a vapor fuel line 46 that communicates with the fuel tank 42. More specifically, the vapor fuel line 46 has an open or free end which extends into the fuel tank 42. The open end of the vapor fuel line 46 can be positioned above the liquid level in the fuel tank 42, at least while the pressure reducing device 38 is in operation. As depicted by this embodiment, the fuel tank 42 houses the liquid fuel that is carried by the liquid fuel rail 30 to the liquid fuel injectors 22a-22d. It should be appreciated, however, that the liquid fuel delivered to the engine 14 could be contained in another housing or separate chamber from the fuel tank from which fuel is obtained or selected to be carried by the vapor fuel line 46.

The pressure reducing device 38 is devised to extract only, or substantially only, fuel vapor from the fuel tank 42 for output to a discharge line 50 that has a number of output ports 54a, 54b, 54c, 54d. Each of these ports 54a-54d communicates with one of the cylinders 22a-22d, respectively. In other embodiments, the number of ports is different from the number of cylinders 22a-22d, such as there being a single port 54 comprising a single vapor inlet. The ports 54a-54d are illustrated as being upstream of the liquid fuel injectors 26a-26d; however, the ports 54a-54d could be positioned at any location upstream of the engine intake, including downstream of the fuel injectors 26a-26d. Although the vapor fuel line 46 carries only, or substantially only, fuel vapor, the discharge line 50 may carry some liquid fuel that might be produced due to re-condensing of the fuel vapor since the discharge side of the pressure reducing device 38 is at a higher pressure than its fuel tank side. Regardless, such fuel, even if partially liquid, vaporizes under intake manifold conditions much more readily than the liquid fuel in the fuel tank 42. In accordance with embodiments of the present invention, the ports 54 may comprise calibrated orifices, in order to control the amount of vapor provided to the cylinders 22. In yet another embodiment, the vacuum pump 38 is operated to control the quantity of vaporized fuel that is metered to the cylinders 22, and the magnitude of the negative pressure is varied in response to the vapor fuel quantity requirement of the engine 14. In accordance with additional or alternative embodiments of the present invention, the pressure reducing device 38 may comprise a pump calibrated to provide the output ports 54 with fuel vapor at a selected pressure, in order to control the amount of vapor provided to the cylinders 22. In accordance with still other embodiments of the present invention, the output ports 54 may comprise vapor fuel injectors, to allow the amount of fuel vapor provided to a cylinder 22 to be precisely controlled.

With regard to operation, engine 14, including the fuel injectors 26a-26d, are controlled in known manners except during a cold start, which can be defined as the engine coolant temperature being detected as below a certain threshold temperature and the first tens of seconds following the start or ignition of the engine 14. Accordingly, the engine 14 may include a coolant temperature sensor 62. Alternatively or in addition, a signal from an oil temperature sensor 66 and/or an exhaust temperature sensor 70 that may be provided as part of the engine 14 may be used to determine when the engine 14 is in a cold start condition. During the cold start, the device 38 is actuated, which can be before the engine 14 is ignited or started. The pressure reducing device 38, such as the vacuum pump, once activated, reduces the ambient pressure in the fuel tank 42. At low ambient pressures, the most volatile fuel components vaporize and are drawn by the vacuum pump. Hence, the initial or start-up fuel is comprised selectively of the most volatile fraction of fuel. In one embodiment, the magnitude of the negative pressure can be controlled based on one or more factors, such as ambient temperature. In another embodiment, the negative pressure that is created is substantially the same at all times, even without regard to ambient temperature.

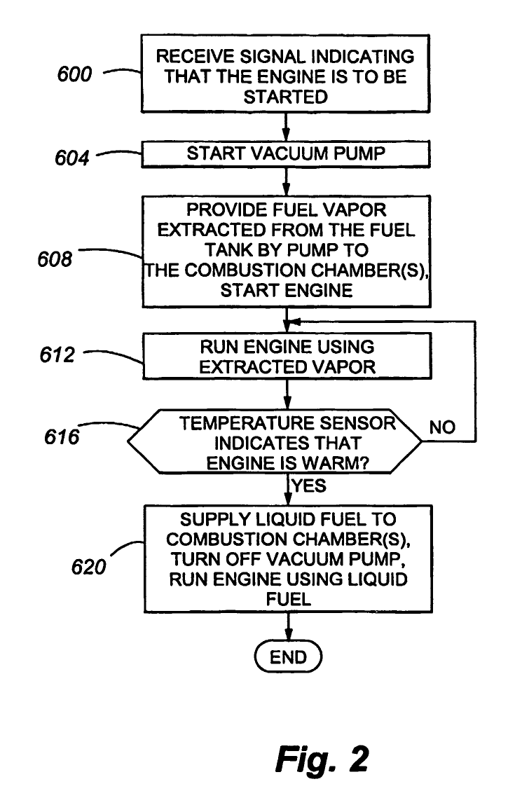

With reference now to FIG. 2, aspects of the operation of embodiments of the present invention are depicted. Initially, at step 600, a signal indicating that the engine is to be started is received. The signal may be generated in response to a key being placed in an ignition switch, in response to user selection of a “start button”, after an ignition switch is turned to on, or any other action indicating that the associated engine is to be started. After receiving the signal that the engine is to be started, the pressure reducing device 38, such as a vacuum pump, is started (step 604). Operation of the pressure reducing device 38 creates a partial vacuum in the fuel tank 42. In accordance with alternative embodiments of the present invention, the pressure reducing device 38 may be operated intermittently, in order to always or usually maintain a partial vacuum in the portion of the fuel tank 42 occupied by fuel vapor.

The fuel vapor extracted from the fuel tank 42 by the pressure reducing device or pump 38 is then provided to the cylinders or combustion chambers 22 via the output ports 54, and the engine is started (step 608). By using the volatile components of the fuel contained in the fuel vapor, the emissions of hydrocarbons and carbon monoxide from the engine 14 are reduced, as compared to start up at similar temperatures using liquid fuel. In addition, drivability is improved. After the initial start, the engine 14 continues to be run using the extracted fuel vapor (step 612).

At step 616, a determination is made as to whether the engine is sufficiently warm to begin using liquid fuel. For example, a determination may be made as to whether a signal from an engine coolant temperature sensor 62, engine oil temperature sensor 66, and/or engine exhaust gas temperature sensor 70 indicates that the engine is warm enough to use liquid fuel. Alternatively, the engine may be determined to be warm enough to begin using liquid fuel after a predetermined amount of time has elapsed since the engine was initially started. If the engine is not sufficiently warm to begin using liquid fuel, the processor returns to step 612, and the engine continues to be run using extracted fuel vapor. If at step 616 it is determined that the engine is warm, liquid fuel is provided to the combustion chambers or cylinders 22 (step 620). Also at step 620, the pressure reducing device or vacuum pump 38 may be turned off, and the engine is run using liquid fuel. The transition from fuel vapor to liquid fuel may be gradual. For instance, the pressure reducing device 38 may continue to be operated, providing fuel vapor to the cylinders 22 through the output ports 54, at the same time that the liquid fuel injectors 26 are operated to provide liquid fuel to those cylinders 22. As can also be appreciated by one of skill in the art, metering of the fuel provided by the liquid fuel injectors 26 can be provided by conventional fuel injection control systems, even during a transition period during which fuel vapor continues to be provided to the cylinders 22. In accordance with further embodiments of the present invention, the transition from fuel vapor operation to liquid fuel operation can be abrupt. For instance, the pressure reducing device 38 can turned off, to discontinue the provision of fuel vapor, and liquid fuel can then be provided.

As can be appreciated by one of skill in the art from the description provided herein, the period during which fuel vapor is provided to the cylinders 22 may vary. For instance, liquid fuel may be provided by the liquid fuel injectors 26 almost immediately after the engine 14 is started, where the engine 14 is relatively warm. Furthermore, where the engine 14 is hot, the provision of fuel vapor may be bypassed entirely. In addition to transitioning to liquid fuel in response to receiving a useable signal from a temperature sensor, other types of sensors and/or timers may be applied. For instance, an engine coolant temperature sensor 62, engine oil temperature sensor 66, exhaust temperature sensor 70, or a sensor providing a temperature of a component or part of the engine 14 may be used to determine the period of time during which fuel vapor is provided to the cylinders 22. Alternatively or in addition, a timer may be provided, for example as part of a timer algorithm implemented by a controller.

Therefore, a timer may be used to switch from vapor to liquid fuel operation after a predetermined period of time has elapsed. In accordance with embodiments of the present invention, fuel vapor may therefore be provided to the cylinders 22 by operation of the pressure reducing device 38 and the output ports 54 within a range of from 0-90 seconds. As can be appreciated, in extreme conditions, the period of time during which fuel vapor is provided to the cylinders 22 may be even longer. Furthermore, the period of time during which fuel vapor is provided may vary from start to start, for example when that period is determined with reference to a temperature sensor input, a time since the previous start, or some other variable.

As can also be appreciated by one of skill in the art from the description provided herein, control of an assembly 18 for providing fuel vapor to the cylinders 22 of an engine 14 may be implemented in connection with a controller 74 using logic provided by hardware, or program instructions in association with hardware. In accordance with still other embodiments of the present invention, control of the assembly 18 may be performed by suitable programming and interconnection of a controller 74 associated with an otherwise conventional control system that is also used for operating the liquid fuel injection system of the engine 14.

Although the description provided herein has used as examples engines 14 having one or more cylinders 22 and pistons, embodiments of the present invention are not so limited. For instance, embodiments of the present invention can be applied in connection with rotary engines. In general, the present invention may be used in connection with any spark ignited engine that is normally provided with a liquid fuel.

The present invention improves cold start behavior of gasoline engines to reduce emissions of hydrocarbons and carbon monoxide, while improving drivability. By reducing the engine-out emissions of hydrocarbons, it may be possible to reduce precious metal loading of the catalyst, which could result in net cost savings to the vehicle manufacturer. The present invention is less complicated and less costly to implement than systems and methods that require a distillation system, such as a heat exchanger and condenser, as well as systems that require an additional fuel tank or an additional fuel pump. The cost of the vacuum pump, start-up fuel metering hardware and any controller complexity is thought to be low in comparison to potential cost savings due to excess precious metals in the catalyst. Furthermore, the only source of the most volatile fraction of the fuel, such as the fuel vapor, need be the same fuel tank that houses the liquid fuel used during regular or normal engine operation. Moreover, embodiments of the present invention do not rely solely on any vacuum or other negative pressure created by the engine when started. Instead, embodiments of the present invention may include a separate device for reducing pressure, such as a vacuum pump, for providing fuel vapor to a combustion chamber of an engine during cold start. Additionally, it is possible to activate the vacuum pump to provide reduced ambient pressure fuel before the engine is ignited or started. In accordance with still other embodiments of the present invention, fuel vapor may be provided to a combustion chamber of an engine during cold start using a vacuum created by movement of a piston or component within the combustion chamber, without requiring an additional pressure reducing device. In accordance with still other embodiments of the present invention, a vacuum accumulator may be used to store a vacuum produced by the engine for later use in connection with providing fuel vapor for starting the engine.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently know of practicing the invention and to enable others skilled in the art to utilize the invention in such or in other embodiments and with various modifications required by their particular application or use of the invention. It is intended that the appended claims be construed to include the alternative embodiments to the extent permitted by the prior art.

What is claimed is:

1. A method for controlling engine start-up, comprising:
providing fuel using a fuel tank and in which at least a majority of said fuel is fuel vapor; and
supplying at least some of said fuel vapor obtained during said providing to the engine, wherein said fuel vapor from said supplying is the only fuel vapor used during said engine start-up.

2. The method of claim 1, wherein said fuel tank houses liquid fuel.

3. The method of claim 1, wherein said providing includes using a device to create a negative pressure.

4. The method of claim 1, wherein said providing includes providing said fuel vapor at ambient temperature.

5. The method of claim 1, wherein said fuel tank contains the only source of fuel for the engine start-up and for engine operation other than start-up.

6. The method of claim 1, wherein said providing includes reducing an ambient pressure of said fuel independently of the engine.

7. The method of claim 1, wherein said providing is conducted before ignition of the engine as part of its start-up.

8. The method of claim 1, wherein substantially all of said fuel provided is fuel vapor.

9. The method of claim 3, wherein said device has a discharge side and at least portions of said fuel vapor re-condense adjacent said discharge side.

10. The method of claim 1, further comprising:
after said engine has warmed up, supplying liquid fuel to said engine.

11. An assembly that when activated provides fuel vapor for use in engine start-up, comprising:
a fuel tank that contains fuel;
a vapor fuel line communicating with said fuel tank; and
a device that creates a negative pressure for use in controlling movement of fuel vapor to the engine, wherein said device is different than the engine.

12. The assembly of claim 11 wherein said device includes a vacuum pump disposed along said vapor fuel line between said fuel tank and the engine.

13. The assembly of claim 11 wherein said fuel tank contains liquid fuel that is used by the engine after start-up.

14. The assembly of claim 11 wherein said fuel vapor is provided to the engine independently of any vacuum created by the engine.

15. The assembly of claim 11 wherein said device is activated before the engine is ignited.

16. The assembly of claim 11 wherein said fuel vapor is at ambient temperature.

17. The assembly of claim 11 wherein said fuel tank is the only source of said fuel vapor used by the engine during start-up.

18. A method for starting an engine, comprising:
drawing vapor from a liquid fuel tank; and
supplying said vapor drawn from said liquid fuel tank to at least a first combustion chamber of said engine, wherein said engine is started using said vapor.

19. The method of claim 18, further comprising:
monitoring a temperature of said engine; and
in response to said temperature exceeding a predetermined level, providing liquid fuel to said at least a first combustion chamber.

20. The method of claim 19, wherein said monitoring a temperature of said engine comprises monitoring a temperature of at least one of engine coolant, engine oil, engine exhaust, and an engine component.

21. The method of claim 19, further comprising in response to said temperature exceeding said predetermined level, ceasing to supply said vapor drawn from said liquid fuel tank.

22. The method of claim 18, further comprising:
after starting said engine, initiating a timer; and
in response to said timer indicating that a predetermined period of time has elapsed, providing liquid fuel to said at least a first combustion chamber.

23. The method of claim 18, further comprising:
after starting said engine, providing liquid fuel to said engine, wherein said vapor drawn from said liquid fuel to at least a first combustion chamber is abruptly stopped.

24. The method of claim 18, further comprising:
after starting said engine, providing liquid fuel to said engine, wherein supplying said vapor drawn from said liquid fuel to said at least a first combustion chamber is gradually stopped.
